(19) United States
(12) Patent Application Publication
(10) Pub. No.: US 2018/0124700 A1
(43) Pub. Date: May 3, 2018

(54) TRANSMIT POWER CONFIGURATION BASED ON BANDWIDTH

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US)

(21) Appl. No.: 15/799,985

(22) Filed: Oct. 31, 2017

Related U.S. Application Data
(60) Provisional application No. 62/416,055, filed on Nov. 1, 2016.

(51) Int. Cl. H04W 52/02; H04W 52/18

(52) U.S. Cl. CPC H04W 52/0212; H04W 84/12; H04W 52/0229; H04W 52/18

(57) ABSTRACT

A method, an apparatus, and a computer-readable medium for wireless communication are provided. In one aspect, the apparatus is configured to receive a soliciting message with a first bandwidth. The apparatus is configured to select a second bandwidth for transmission of a response message in response to the soliciting message, the second bandwidth being different from the first bandwidth. The apparatus is configured to determine a transmit power for the transmission of the response message based on a ratio of the second bandwidth and the first bandwidth.

### CROSS-REFERENCE TO RELATED APPLICATION(S)

This application claims the benefit of U.S. Provisional Application Ser. No. 62/416,055 entitled “TRANSMIT POWER CONFIGURATION BASED ON BANDWIDTH” filed on Nov. 1, 2016, which is expressly incorporated by reference herein in its entirety.

### BACKGROUND

### Field

The present disclosure relates generally to communication systems, and more particularly, to configuring a transmit power for a wireless device based on a bandwidth used for a transmission.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of the present disclosure provides a wireless device (e.g., a station) for wireless communication. The wireless device may be configured to receive a soliciting message with a first bandwidth. The wireless device may be further configured to select a second bandwidth for transmission of a response message in response to the soliciting message, the second bandwidth being different from the first bandwidth. The wireless device may be further configured to determine a transmit power for the transmission of the response message based on a ratio of the second bandwidth and the first bandwidth.

### BRIEF DESCRIPTION OF THE DRAWINGS

FIG. 1 shows an example wireless communication system in which aspects of the present disclosure may be employed.

FIG. 2A is an example diagram illustrating a bandwidth for a soliciting message and a bandwidth for a response.

FIG. 2B is another example diagram illustrating a bandwidth for a soliciting message and a bandwidth for a response.

FIG. 3 is an example diagram illustrating communication between a soliciting STA and a responding STA, and processing involved in configuration of a transmit power according to an aspect of the disclosure.

FIG. 4A is an example diagram illustrating use of a narrower bandwidth for transmission of a response to a soliciting message, according to an aspect of the disclosure.

FIG. 4B is an example diagram illustrating use of a larger bandwidth for transmission of a response to a soliciting message, according to an aspect of the disclosure.

FIG. 5 is a functional block diagram of a wireless device that may be employed within the wireless communication system of FIG. 1 for wireless communication.

FIG. 6 is a flowchart of an example method of for wireless communication.

FIG. 7 is a functional block diagram of an example wireless communication device for wireless communication.

### DETAILED DESCRIPTION

Various aspects of the novel systems, apparatuses, computer-readable medium, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

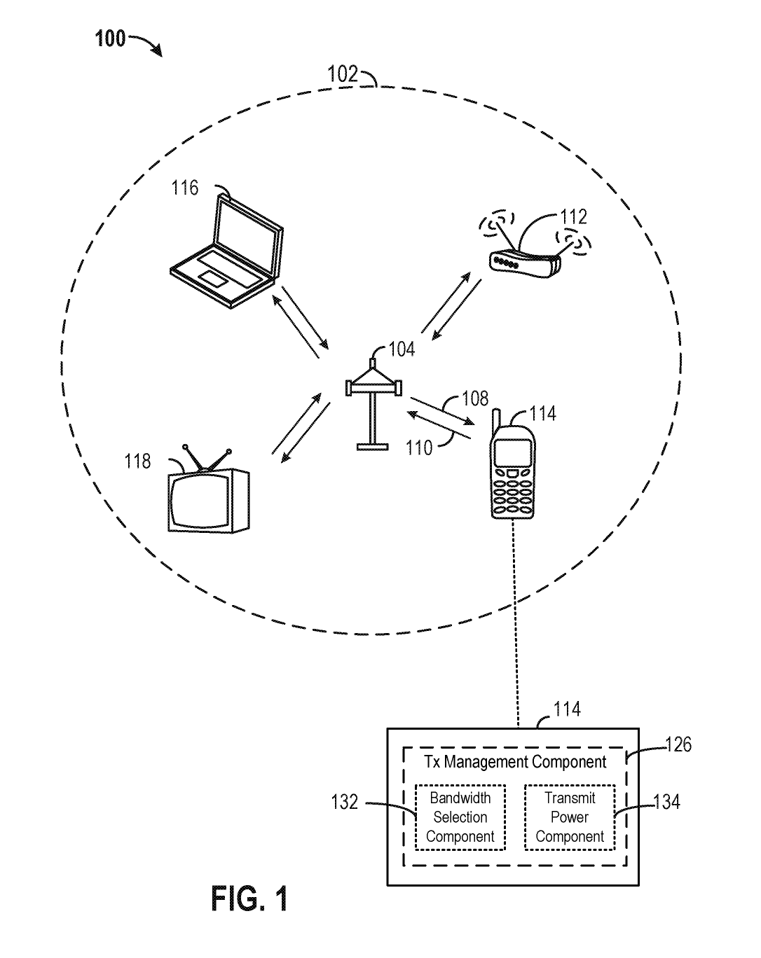

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components (or circuits) for performing various functions. For example, the STA 114 may include a transmission management component 126 configured to perform wireless communication by the STA 114. The transmission management component 126 may include a bandwidth selection component 132 and a transmit power component 134. In this example, the transmission management component 126 may be configured to receive a soliciting message with a first bandwidth. The bandwidth selection component 132 of the transmission management component 126 may be configured to select a second bandwidth for transmission of a response message in response to the soliciting message, the second bandwidth being different from the first bandwidth. The transmit power component 134 of the transmission management component 126 may be configured to determine a transmit power for the transmission of the response message based on a ratio of the second bandwidth and the first bandwidth.

A first wireless device (e.g., a STA or an AP) may solicit a response from a second wireless device, and the second wireless device may send the response. Thus, the first wireless device may be referred to as a soliciting device, and the second wireless device may be referred to as a responding device. In an aspect, a soliciting device may transmit a soliciting message to a responding device to solicit a response from the responding device, where the soliciting message may include a physical layer convergence protocol (PLCP) protocol data unit (PPDU). A bandwidth for transmission of the response may be the same as a bandwidth for receiving a soliciting PPDU, except for a clear-to-send (CTS) frame. For example, if a STA receives a soliciting message in a bandwidth of 160 MHz, the STA may transmit a response (in response to the soliciting message) in a bandwidth of 160 MHz. However, transmitting the response message in the same bandwidth as the bandwidth for receiving the soliciting message may not always be an optimal choice. For example, in cases where there may be a power imbalance between the transmitting STA (e.g., soliciting STA) and the receiving STA (e.g., responding STA), transmitting a response message in the same bandwidth as the bandwidth for receiving a soliciting message may cause issues. In particular, in cases of power imbalance, configuring a STA with link deficiency to transmit in a lower bandwidth may be advantageous. For example, if a responding STA has link deficiency, configuring the responding STA to send a response (in response to a soliciting message) in a bandwidth lower than a bandwidth for receiving the soliciting message may be more advantageous because more transmit power may be concentrated in a narrower bandwidth than in a broader bandwidth (e.g., because in an example of sending the response in a broader bandwidth, the transmit power may be spread out over the broader bandwidth).

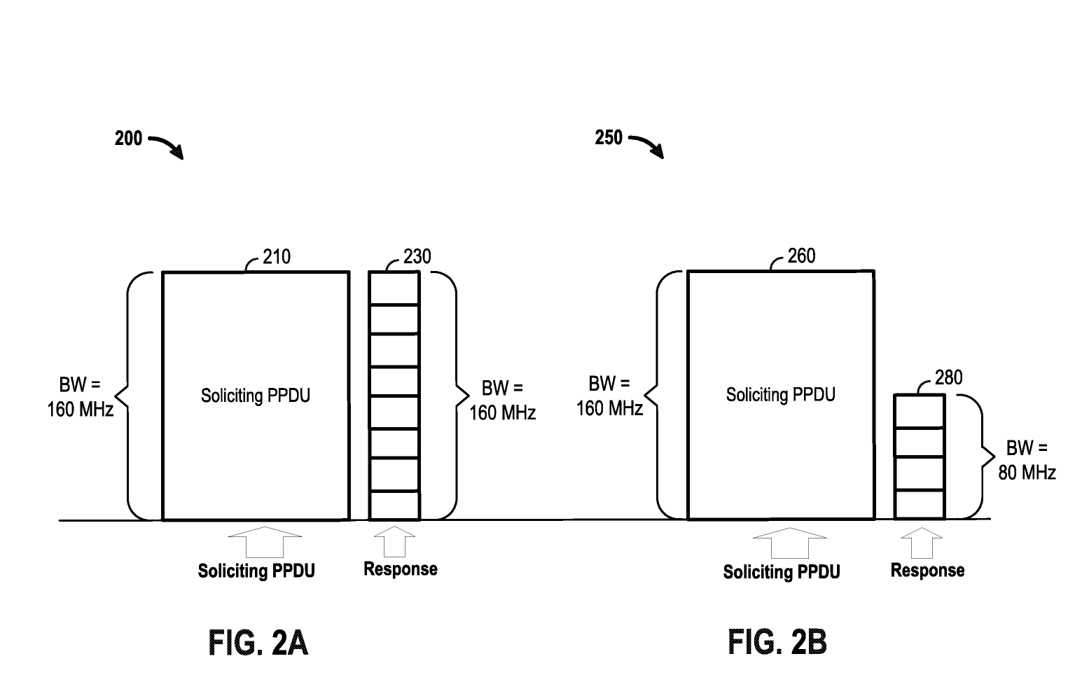

FIG. 2A is an example diagram 200 illustrating a bandwidth for a soliciting message and a bandwidth for a response. In the example diagram 200, when a soliciting STA transmits a soliciting PPDU 210 using a bandwidth of 160 MHz, a responding STA receives the soliciting PPDU 210 in the bandwidth of 160 MHz. The responding STA transmits a response 230 in response to the soliciting PPDU using a bandwidth of 160 MHz. Thus, in the example diagram 200, the responding STA uses the same bandwidth to transmit the response 230 as the bandwidth for receiving the soliciting PPDU 210. FIG. 2B is another example diagram 250 illustrating a bandwidth for a soliciting message and a bandwidth for a response. In the example diagram 250, when a soliciting STA transmits a soliciting PPDU 260 (e.g., a soliciting message) using a bandwidth of 160 MHz, a responding STA receives the soliciting PPDU 260 in the bandwidth of 160 MHz. The responding STA transmits a response 280 in response to the soliciting PPDU 260 using a bandwidth of 80 MHz. Thus, in the example diagram 250, the responding STA uses a different bandwidth to transmit the response 280 than the bandwidth for receiving the soliciting PPDU 260.

In one example approach, a STA (e.g., responding STA) may utilize a transmit power that the STA would use to transmit a response had the STA used the same bandwidth for transmission of the response as the bandwidth for receiving the response, regardless of a size of a bandwidth for transmission of the response. However, with such an approach, if the responding STA utilizes a narrower bandwidth for transmission of the response (than a bandwidth used for receiving the soliciting message) while using a transmit power that the STA would have used when transmitting the response using the same bandwidth as used for transmission of the soliciting PPDU 260, the interference generated by using the narrower bandwidth and the same transmit power (suitable for transmission in broader bandwidth) may be high. For example, in a case where both the soliciting device and the responding device use the same transmit power (e.g., 20 dBm) for wireless communication, if a soliciting device transmits a soliciting message using 160 MHz and the responding device transmits a response at 80 MHz, the interference generated by using a 80 MHz bandwidth transmission may be significantly higher than the interference generated by using a 160 MHz bandwidth transmission. Hence, an approach to set a transmit power based on a bandwidth is desired (e.g., when a bandwidth used to transmit a response is different from a bandwidth used to receive a soliciting message).

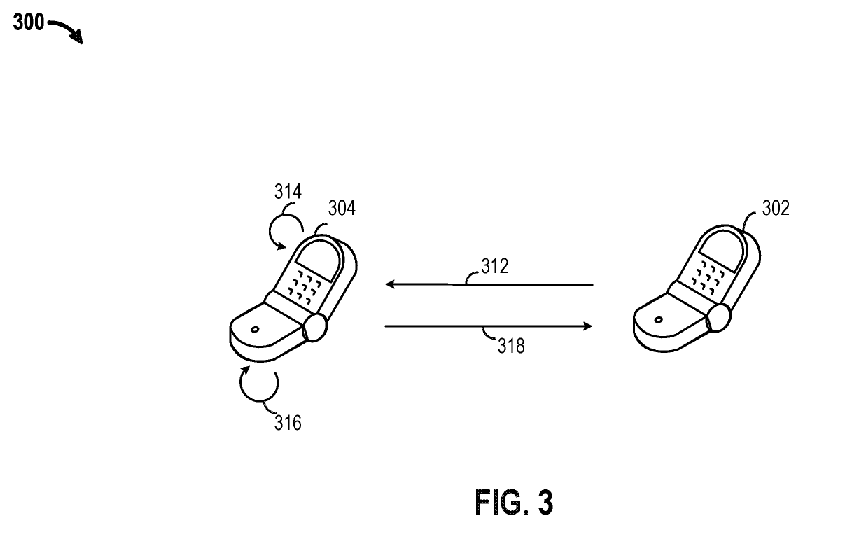

According to an aspect of the disclosure, a STA (e.g., responding STA) may select a second bandwidth for transmission of a response to a soliciting message, where the second bandwidth is different from a first bandwidth for receiving the soliciting message. In one configuration, the STA may set a transmit power for transmission of the response based on the first bandwidth and the second bandwidth. In an aspect, the response may be a control response (e.g., a clear-to-send frame). FIG. 3 is an example diagram 300 illustrating communication between a soliciting STA 302 and a responding STA 304 and processing involved in configuration of a transmit power according to an aspect of the disclosure. The interaction/communication between the soliciting STA 302 and the responding STA 304 is illustrated by the arrows between the STAs 302, 304. As illustrated, the soliciting STA 302 may transmit a soliciting message 312 (e.g., soliciting PPDU) to the responding STA 304, e.g., using a first bandwidth. In one configuration, the responding STA 304 may determine (314) a second bandwidth to be used for transmission of a response 318 to the soliciting PPDU. In such a configuration, the responding STA 304 may determine (316) a transmit power for transmission of the response 318 to the soliciting PPDU based on the first bandwidth and the second bandwidth. The responding STA 304 may transmit the response 318 to the soliciting STA 302 in the second bandwidth using the determined transmit power.

In accordance with an aspect, the responding STA (e.g., responding STA 304) may be configured to determine (316) the transmit power such that a power spectral density (PSD) of the response 318 (transmitted using the second bandwidth) matches a PSD that would be achieved had the first bandwidth been used for the transmission of the response 318, where the first bandwidth is bandwidth used for transmission of the soliciting message 312. For example, in one configuration, if the second bandwidth used for transmission of the response is narrower than the first bandwidth, a reduced transmit power for transmission of the response in the second (e.g., narrower) bandwidth may be used, where the reduced transmit power may be proportional to the reduction in the second bandwidth relative to the first bandwidth. This allows for maintaining the same power spectral density for the response as would have been achieved had the first bandwidth was used for transmission of response as discussed above.

In an aspect, to determine the transmit power for transmission of the response in the second bandwidth, a transmit power for transmission in the first bandwidth may be scaled based on a ratio of the second bandwidth to the first bandwidth. Thus, the transmit power for the transmission of the response in the second bandwidth may be expressed as

$${P}_{tx \_ BW 1} \times \frac{BW 2}{BW 1} ,$$

where BW1 is a first bandwidth, BW2 is a second bandwidth, and Pₜₓ_{_}_{BW1} is a transmit power for BW1, as long as there is no limit on the transmit power that the responding STA can use. In an aspect, the first bandwidth associated with the soliciting message may be a full bandwidth (e.g., largest bandwidth) that the responding STA is capable of using for transmission of soliciting message or other similar types of messages. In an aspect, when the responding STA sets the transmit power for the transmission of the response, the transmit power may be limited by a transmit power upper limit of the responding STA. Hence, if the transmit power determined for the second bandwidth (e.g., based on the above discussed bandwidth ratio criteria) for transmission of a response message is greater than the transmit power upper limit, the responding STA may utilize the transmit power upper limit (instead of the determined transmit power) to transmit the response message in the second bandwidth. Accordingly, in a case where the responding STA has a transmit power upper limit, the transmit power for transmitting a response may be expressed, for example, as:

$${P}_{t x \_ response} = Max ( {P}_{t x \_ BW 1} \times \frac{BW 2}{BW 1} , {P}_{tx \_ upper \_ limi t} ) ,$$

where Pₜₓ_{_}ᵣₑₛₚₒₙₛₑ is a transmit power for transmitting a response in a second bandwidth, BW1 is a first bandwidth, BW2 is the second bandwidth, Pₜₓ_{_}_{BW1} is a transmit power for transmitting in the first bandwidth, and Pₜₓ_{_}ᵤₚₚₑᵣ_{_}ₗᵢₘᵢₜ the transmit power upper limit.

In one example, the responding STA may receive a soliciting message in a first bandwidth and may determine a second bandwidth for transmission of a response. In such an example, where the second bandwidth is narrower than the first bandwidth, then scaling based on a ratio of the second bandwidth and the first bandwidth may result in a transmit power that is less than the transmit power for the first bandwidth. Further, in another example, if the responding STA receives a soliciting message in a first bandwidth and determines a second bandwidth for transmission of a response, where the second bandwidth is greater than the first bandwidth, scaling based on a ratio of the second bandwidth to the first bandwidth may result in a transmit power that is greater than the transmit power for the first bandwidth. In an aspect, the STA may be configured to expand its bandwidth such that the responding STA may transmit its own frames during a reserved time period.

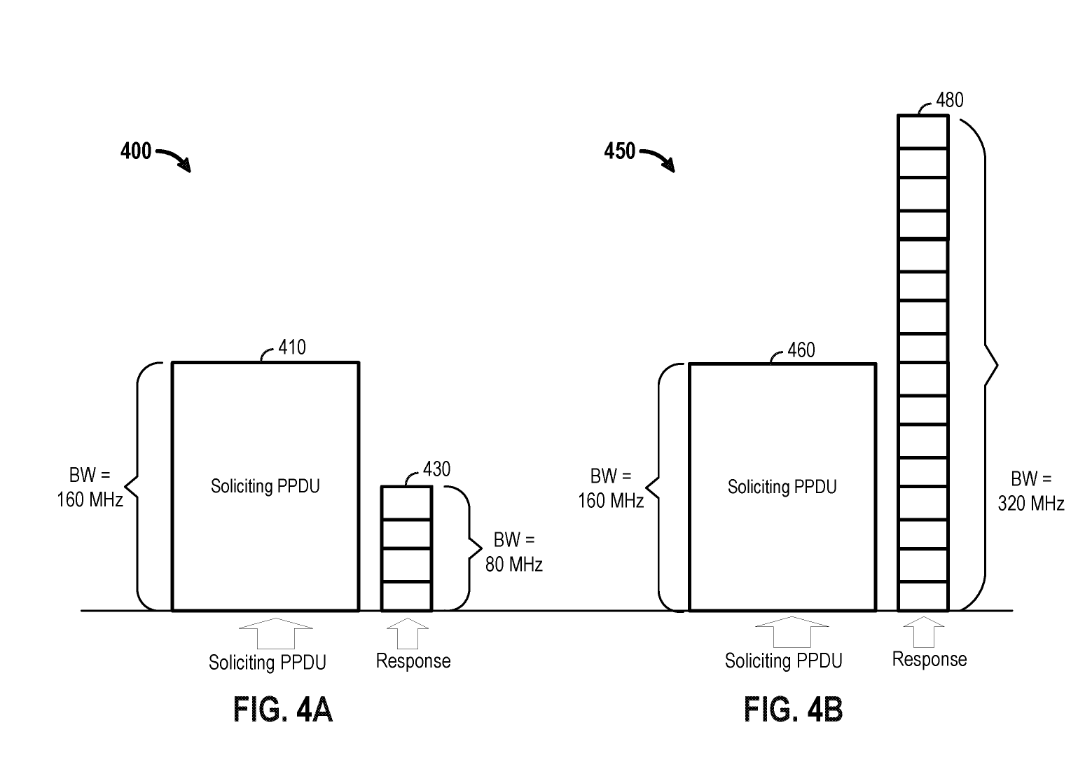

FIG. 4A is an example diagram 400 illustrating use of a narrower bandwidth for transmission of a response to a soliciting message than a bandwidth associated with the soliciting message, according to an aspect of the disclosure. In the example diagram 400, a responding STA receives a soliciting message, e.g., soliciting PPDU 410, in a first bandwidth of 160 MHz. For example, the received soliciting PPDU 410 may occupy a 160 MHz bandwidth. The responding STA transmits a response 430, in response to the soliciting PPDU 410, in a second bandwidth of 80 MHz. Thus, in the example diagram 400, because the ratio of the second bandwidth to the first bandwidth is

$$\frac{BW 2}{BW 1} = 1 \text{/} 2 ,$$

the responding STA determines the transmit power for transmission of the response by multiplying ½ to an initial transmit power, e.g., a transmit power that the responding STA would have used if the bandwidth of 160 MHz was used for transmission of the response. For example, to determine the transmit power for transmission of the response, the responding STA may reduce the transmit power from the transmission of the soliciting PPDU 410 by 3 dBm. The transmit power used for transmission of the response using the same (i.e., first) bandwidth as the soliciting PPDU 410 may be known (e.g., preconfigured) to the responding STA and/or determined based on data received by the responding STA. For example, if the responding STA is configured to use 10 dBm transmit power for transmitting the response using the first bandwidth of 160 MHz, the responding STA may determine that the transmit power to transmit a response at the second bandwidth of 80 MHz is 7 dBm, which is a 3 dBm reduction (e.g., one half (½) reduction in Watts) from 10 dBm. With the 3 dBm reduction, the transmission of the response using the 7 dBm transmit power in the 80 MHz bandwidth may result in a PSD that matches a PSD from a transmission using the 10 dBm transmit power in the 160 MHz bandwidth. Thus, using an adjusted transmit power proportionally with the change in bandwidth used for transmission of the response may allow for maintaining a substantially constant PSD.

FIG. 4B is an example diagram 450 illustrating use of a larger bandwidth for transmission of a response to a soliciting message than a bandwidth associated with the soliciting message, according to an aspect of the disclosure. In the example diagram 450, a responding STA receives a soliciting PPDU 460 in a first bandwidth of 160 MHz. The responding STA transmits a response 480 in response to the soliciting PPDU 460 in a second bandwidth of 320 MHz. Thus, in the example diagram 450, because the ratio of the second bandwidth to the first bandwidth is

$$\frac{BW 2}{BW 1} = 2 ,$$

the responding STA determines the transmit power for transmission of the response 480 by doubling (e.g., in Watts) a transmit power that the responding STA would have used had the responding STA used the same bandwidth as the soliciting message, i.e., 160 MHz in this example. For example, to obtain the transmit power for transmission of the response, the responding STA may increase the transmit power from the transmission of the soliciting PPDU 410 by 3 dBm. For example, if the responding STA is configured to use 10 dBm transmit power for transmitting at the first bandwidth of 160 MHz, the responding STA may determine that the transmit power to transmit the response 480 at the second bandwidth of 320 MHz is 13 dBm, which is a 3 dBm increase (e.g., a two-fold increase in Watts) from 10 dBm. With the 3 dBm increase, transmission of the response 480 using the 13 dBm transmit power in the 320 MHz bandwidth may result in a PSD that matches a PSD from a transmission using the 10 dBm transmit power in the 160 MHz bandwidth.

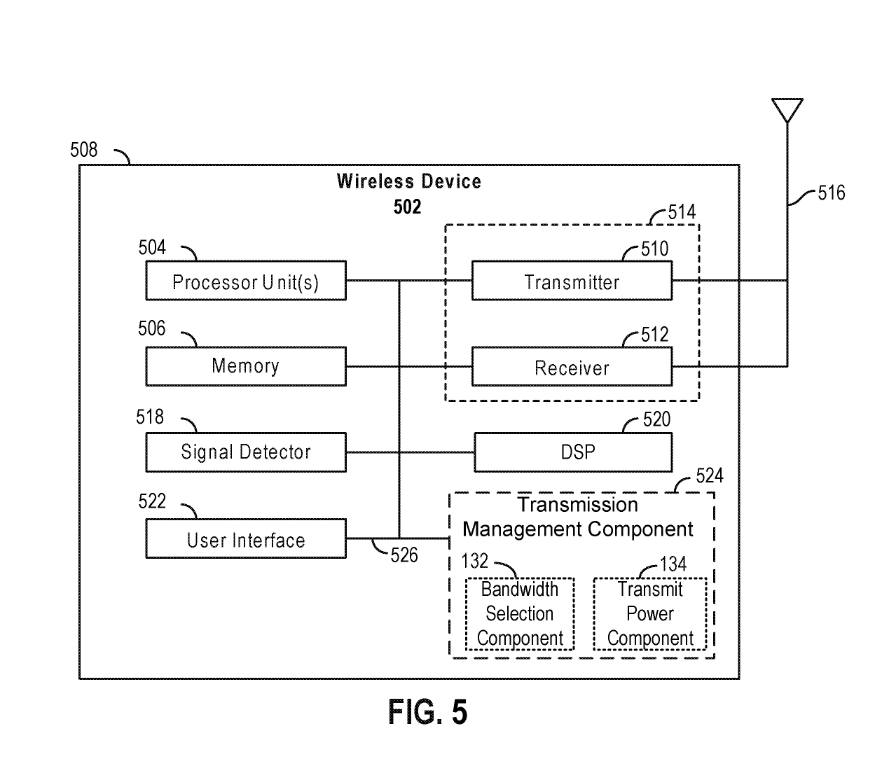

FIG. 5 is a functional block diagram of a wireless device 502 that may be employed within the wireless communication system 100 of FIG. 1 for wireless (e.g., OFDMA) transmission. The wireless device 502 is an example of a device that may be configured to implement the various methods described herein. For example, the wireless device 502 may comprise the STA 114 or the responding STA 304.

The wireless device 502 may include a processor 504 which controls operation of the wireless device 502. The processor 504 may also be referred to as a central processing unit (CPU). Memory 506, which may include both read-only memory (ROM) and random access memory (RAM), may provide instructions and data to the processor 504. A portion of the memory 506 may also include non-volatile random access memory (NVRAM). The processor 504 typically performs logical and arithmetic operations based on program instructions stored within the memory 506. The instructions in the memory 506 may be executable (by the processor 504, for example) to implement the methods described herein.

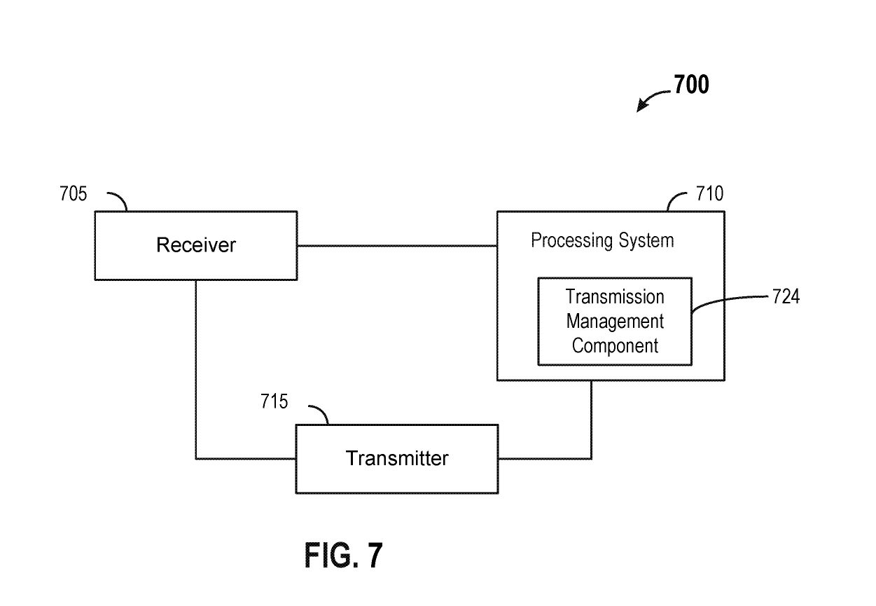

The processor 504 may comprise or be a component of a processing system (such as the example system illustrated in FIG. 7) implemented with one or more processors. The one or more processors may be implemented with any combination of general-purpose microprocessors, microcontrollers, digital signal processors (DSPs), field programmable gate array (FPGAs), programmable logic devices (PLDs), application specific integrated circuits (ASICs), controllers, state machines, gated logic, discrete hardware components, dedicated hardware finite state machines, or any other suitable entities that can perform calculations or other manipulations of information. In an aspect, the techniques, methods, etc., may be implemented in a modem processor, also referred to as a baseband processor.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein, including, for example, the operations illustrated by the blocks of the flowcharts described herein.

The wireless device 502 may also include a housing 508, and the wireless device 502 may include a transmitter 510 and/or a receiver 512 to allow transmission and reception of data between the wireless device 502 and a remote device. The transmitter 510 and the receiver 512 may be combined into a transceiver 514. An antenna 516 may be attached to the housing 508 and electrically coupled to the transceiver 514. The wireless device 502 may also include multiple transmitters, multiple receivers, multiple transceivers, and/or multiple antennas. When the wireless device 502 is implemented as a responding STA (e.g., the STA 114, the STA 304), the wireless device 502 may receive, via the receiver 512, soliciting message with a first bandwidth from a soliciting device. For example, in one configuration the wireless device 502 may be implemented as the responding STA 304. In such a configuration, the receiver 512 may be configured to receive the soliciting message 312 (e.g., including a soliciting PPDU shown in the various preceding figures) with a first bandwidth. Furthermore, in some such configurations, the transmitter 510 alone, in combination with and/or under the control of the transmission management component 524, may be configured to transmit a response message (e.g., in response to a soliciting message) at a transmit power determined in accordance with the methods described herein and as discussed further below.

The wireless device 502 may also include a signal detector 518 that may be used to detect and quantify the level of signals received by the transceiver 514 or the receiver 512. The signal detector 518 may detect such signals as total energy, energy per subcarrier per symbol, power spectral density, and other signals. The wireless device 502 may also include a DSP 520 for use in processing signals. The DSP 520 may be configured to generate a packet for transmission. In some aspects, the packet may comprise a PPDU.

The wireless device 502 may further comprise a user interface 522 in some aspects. The user interface 522 may comprise a keypad, a microphone, a speaker, and/or a display. The user interface 522 may include any element or component that conveys information to a user of the wireless device 502 and/or receives input from the user.

When the wireless device 502 is implemented as a STA (e.g., the STA 114, the STA 304), the wireless device 502 may also comprise a transmission management component 524. The transmission management component 524 may be configured to perform the functions described herein. The transmission management component 524 may correspond to and/or include the same or similar components as discussed with respect to the transmission management component 126 of FIG. 1. Thus, in one configuration, the transmission management component 524 may include the bandwidth selection component 132 and the transmit power component 134. For example, in one configuration where the wireless device 502 is implemented as a responding STA and receives a soliciting message with a first bandwidth, the bandwidth selection component 132 of the transmission management component 524 may be configured to select a second bandwidth for transmission of a response message in response to the soliciting message, where the second bandwidth may be different from the first bandwidth. In one such configuration, the transmit power component 134 of the transmission management component 524 may be configured to determine a transmit power for the transmission of the response message based on a ratio of the second bandwidth and the first bandwidth.

For example, as discussed in detail supra, the transmit power for the transmission of the response in the second bandwidth may be determined as

$${P}_{tx \_ response} = {P}_{tx \_ BW 1} \times \frac{BW 2}{BW 1}$$

for the case where there is no limit on the transmit power that the responding STA can use. For a power restricted case where the transmit power that may be used for transmission of the response message is restricted by a maximum transmit power allowed for the wireless device 502, the transmission management component 524 may be configured to determine the transmit power in accordance with

$${P}_{t x \_ response} = Max ( {P}_{t x \_ BW 1} \times \frac{BW 2}{BW 1} , {P}_{tx \_ upper \_ limi t} ) ,$$

where the symbols/notations have the same meaning as defined supra. In some configurations, the transmission management component 524 may be configured to reduce an initial transmit power based on the ratio

$$( \frac{BW 2}{BW 1} )$$

to determine the transmit power for transmission of the response message when the second bandwidth is less than the first bandwidth, where the initial transmit power is a transmit power for transmission of the response message with the first bandwidth, e.g., Pₜₓ_{_}_{BW1}. For example, in some such configurations, the initial transmit power may be reduced by multiplying the initial transmit power by the ratio

$$( \frac{BW 2}{BW 1} )$$

when the second bandwidth is less than the first bandwidth.

In some configurations, the transmission management component 524 may be configured to increase an initial transmit power based on the ratio

$$( \frac{BW 2}{BW 1} )$$

to determine the transmit power for transmission of the response message when the second bandwidth is greater than the first bandwidth. For example, in some such configurations, the initial transmit power may be increased by multiplying the initial transmit power by the ratio

$$( \frac{BW 2}{BW 1} )$$

when the second bandwidth is greater than the first bandwidth. In various configurations, the transmitter 510 may be configured to transmit a response message under the control of the transmission management component 524. For example, in one configuration, the transmission management component 524 may control the transmitter 510 to transmit a response message using the determined transmit power (determined by the transmission management component 524 in the manner discussed above) when the determined transmit power is less than or equal to a maximum transmit power for the wireless device 502. In some configurations, the transmission management component 524 may control the transmitter 510 to transmit a response message using the maximum transmit power when the determined transmit power is greater than the maximum transmit power for the wireless device 502.

The various components of the wireless device 502 may be coupled together by a bus system 526. The bus system 526 may include a data bus, for example, as well as a power bus, a control signal bus, and a status signal bus in addition to the data bus. Components of the wireless device 502 may be coupled together or accept or provide inputs to each other using some other mechanism.

Although a number of separate components are illustrated in FIG. 5, one or more of the components may be combined or commonly implemented. For example, the processor 504 may be used to implement not only the functionality described above with respect to the processor 504, but also to implement the functionality described above with respect to the signal detector 518, the DSP 520, the user interface 522, and/or the transmission management component 524. Further, each of the components illustrated in FIG. 5 may be implemented using a plurality of separate elements.

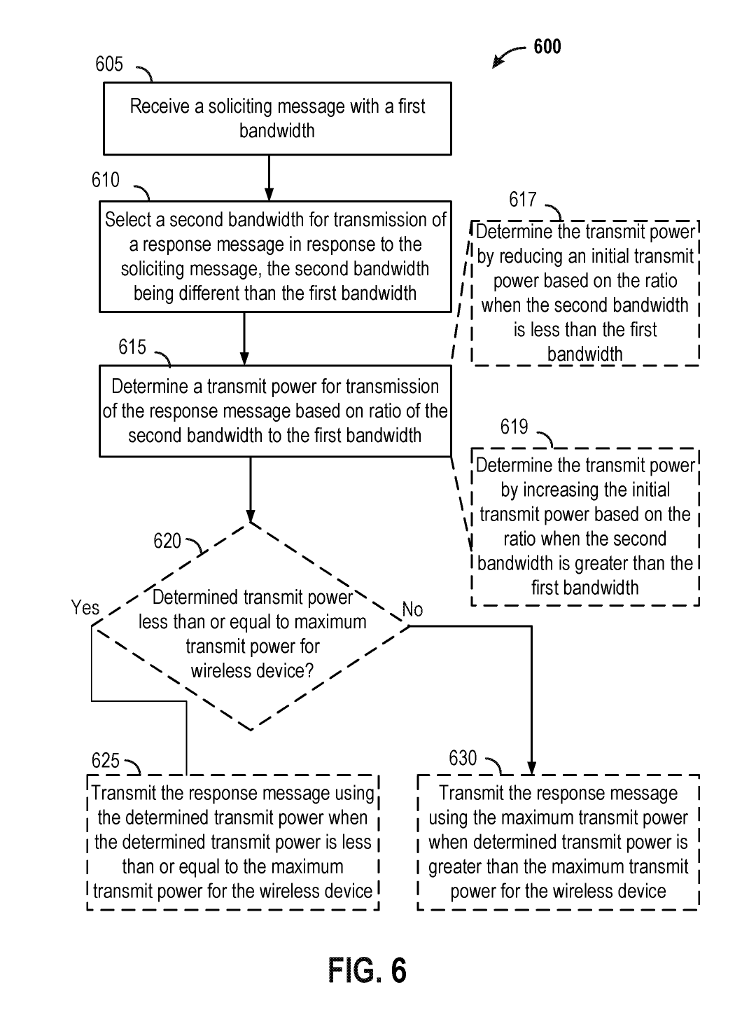

FIG. 6 is a flowchart of an example method 600 of wireless communication. The method 600 may be performed using an apparatus (e.g., the STA 114, the responding STA 304, the wireless device 502, the wireless device 700, or any other device described herein).

At block 605, the apparatus may receive a soliciting message with a first bandwidth. For example, with reference to FIGS. 4A-4B, the soliciting message may be the soliciting PPDU 410/460 which may be received by the apparatus (e.g., a responding STA such as STA 304) from a soliciting STA (e.g., STA 302). As discussed in connection with FIGS. 4A-4B, in one particular configuration the soliciting PPDU 410/460 may be received in a first bandwidth of 160 MHz, e.g., the soliciting PPDU may occupy a bandwidth of 160 MHz.

At block 610, the apparatus may select a second bandwidth for transmission of a response message in response to the soliciting message, the second bandwidth being different from the first bandwidth. For example, there may exist a power imbalance between the soliciting STA (e.g., STA 302) that transmitted the soliciting message and the apparatus (e.g., responding STA 304), and the apparatus may be link deficient. In such a case of power imbalance and link deficiency associated with the apparatus, the apparatus may be configured to use a lower bandwidth (relative to the bandwidth for receiving the soliciting message) for transmission of the response. In some other scenarios, using a higher bandwidth may be feasible. Accordingly, depending on a given condition/scenario, the apparatus may select a different bandwidth for transmission of the response message than the first bandwidth. For example, with reference to FIG. 4A, the responding STA may select a second bandwidth of 80 MHz for transmission of the response message in response to the soliciting PPDU that was received in a first bandwidth of 160 MHz. Thus, in one example configuration, selecting a second bandwidth for transmission of a response message may include selecting a smaller (e.g., narrower) bandwidth than the bandwidth associated with the received soliciting message. In another example discussed in FIG. 4B, the responding STA may select a second bandwidth of 320 MHz for transmission of the response message in response to the soliciting PPDU that was received in a first bandwidth of 160 MHz. In some configurations, the first bandwidth is a full bandwidth that the wireless device is capable of using. Thus, in such an example configuration, selecting a second bandwidth for transmission of a response message may include selecting a larger (e.g., broader) bandwidth than the bandwidth associated with the received soliciting message.

At block 615, the apparatus may determine a transmit power for transmission of the response message based on a ratio of the second bandwidth and the first bandwidth. In an aspect, the apparatus may be configured to determine the transmit power such that the PSD of the response message that may be transmitted using the selected second bandwidth matches a PSD that would be achieved had the first bandwidth been used for the transmission of the response message. In order to achieve a matching PSD, the apparatus may be configured to reduce the transmit power for transmission of the response based on the ratio of the second bandwidth to the first bandwidth when the second bandwidth (for transmission of the response) is less than the first bandwidth associated with the soliciting message, or alternatively increase the transmit power for transmission of the response based on the ratio when the second bandwidth is greater than the first bandwidth. Accordingly, in some configurations, the operation of determining the transmit power (at 615) may include performing one of the operation illustrated at 617 and 619. Thus, in one configuration, at 617 the apparatus may determine the transmit power for transmitting the response message by reducing an initial transmit power to the determined transmit power based on the ratio when the second bandwidth is less than the first bandwidth, where the initial transmit power is a transmit power that may have been otherwise used if the response message was transmitted using the first bandwidth. In one configuration, the initial transmit power may be determined based on data received by the wireless device. In some configurations, reducing the initial transmit power based on the ratio includes multiplying the initial transmit power by the ratio (BW2/BW1) when the second bandwidth is less than the first bandwidth. Thus, when the second bandwidth (selected for transmission of the response message) is less than the first bandwidth, the apparatus may be configured to reduce the initial transmit power by multiplying the initial transmit power by the ratio, where the reduced transmit power is the determined power for transmission of the response message in such cases. For example, in the example case of FIG. 4A where BW2 associated with the response 430 is 80 MHZ as compared to BW1 of 160 MHz associated with the soliciting PPDU 400, the determined transmit power may be equal to 80/160 times (i.e., ½ times) the initial transmit power (e.g., a one half reduction in transmit power).

In one configuration, at 619 the apparatus may determine the transmit power for transmitting the response message by increasing the initial transmit power to the determined the transmit power based on the ratio when the second bandwidth is greater than the first bandwidth. Thus, when the second bandwidth (selected for transmission of the response message) is greater than the first bandwidth, the apparatus may be configured to increase the initial transmit power by multiplying the initial transmit power by the ratio (BW2/BW1), where the increased transmit power is the determined power for transmission of the response message in such cases. For example, in the example case of FIG. 4B where BW2 associated with the response 480 is 320 MHZ as compared to BW1 of 160 MHz associated with the soliciting PPDU 460, the determined transmit power may be equal to 320/160 times (i.e., 2 times) the initial transmit power (e.g., a two fold increase in transmit power).

In some examples, determining a transmit power for a response message transmission based on a bandwidth ratio may be computationally less intensive as compared to some other example approaches where the transmit power may be determined, for example, based on one or more other factors (e.g., a signal to noise (SNR) based on a received message). In the examples where the transmit power determination may be based on other factors (e.g., SNR), the apparatus may need to perform more processing, calculations and/or computations for the transmit power determination as compared to the transmit power determination based on bandwidth ratio. Thus, the example approach of determining the transmit power based on the bandwidth ratio may be computationally more efficient than some other approaches.

Having determined the transmit power for transmission of the response message (e.g., in the manner discussed above with respect to blocks 615, 617, 619), the operation may proceed to block 620 in one configuration. At block 620, the apparatus may determine whether the determined transmit power is less than or equal to a maximum transmit power for the apparatus. The maximum transmit power for the apparatus, e.g., an upper limit of the transmit power that the apparatus may be allowed to use may be known and/or preconfigured. Alternatively, the maximum transmit power that the apparatus is allowed to use may be obtained by the apparatus from an associated AP for a given request-response communication. As illustrated, in some configurations, the operation may proceed to block 625 or 630 based on the determination at 620. For example, if it is determined that the determined transmit power is less than or equal to a maximum transmit power for the apparatus, the operation proceeds to block 625, otherwise the operation proceeds to block 630 as shown.

At block 625, the apparatus may transmit the response message using the determined transmit power when the determined transmit power is less than or equal to a maximum transmit power for the apparatus. In some configurations, the response message is a control response message.

At block 630, the apparatus may transmit the response message using the maximum transmit power when the determined transmit power is greater than the maximum transmit power for the apparatus. In accordance with an aspect, a first power spectral density based on the first bandwidth and a transmit power for transmission with the first bandwidth is substantially equal to a second power spectral density based on the second bandwidth and the determined transmit power for transmission with the second bandwidth.

FIG. 7 is a functional block diagram of an example wireless communication device 700 for wireless (e.g., OFDMA) transmission. The wireless communication device 700 may include a receiver 705, a processing system 710, and a transmitter 715. The processing system 710 may include a transmission management component 724. The receiver 705, the processing system 710, the transmitter 715, and/or the transmission management component 724 may be configured to perform the various function described herein.

The receiver 705, the processing system 710, the transmission management component 724, the receiver 705, and/or the transmitter 715 may be configured to perform one or more functions described herein, such as one or more function described above with respect to blocks 605, 610, 615, 617, 619, 620, 625, and 630 of FIG. 6. For example, the receiver 705 may be configured to perform any receiving function described herein. As another example, the transmitter 715 may be configured to perform any transmission function described herein. As another example, the transmission management component 724 may be configured to perform any bandwidth selection and/or transmit power determination operations described herein. The receiver 705 may correspond to the receiver 512. The processing system 710 may correspond to the processor 504. The transmitter 715 may correspond to the transmitter 510. The transmission management component 724 may correspond to the transmission management component 126 and/or the transmission management component 524 discussed in detail above, and therefore the discussion relating to the functions performed by the transmission management component 724 will not be repeated.

In one configuration, the wireless communication device 700 may comprise means for receiving a soliciting message with a first bandwidth. In one configuration, the wireless communication device 700 may further comprise means for selecting a second bandwidth for transmission of a response message in response to the soliciting message, where the second bandwidth may be different from the first bandwidth. In one configuration, the wireless communication device 700 may further comprise means for determining a transmit power for the transmission of the response message based on a ratio of the second bandwidth and the first bandwidth. In some such configurations, the means for determining the transmit power may be configured to reduce an initial transmit power based on the ratio to determine the transmit power when the second bandwidth is less than the first bandwidth, where the initial transmit power is a transmit power for transmission of the response message with the first bandwidth. For example, in one such configuration, the means for determining may be configured to deduce the determined transmit power by reducing the initial transmit power by multiplying the initial transmit power with the ratio when the second bandwidth is less than the first bandwidth. In some configurations, the means for determining the transmit power may be configured to determine the transmit power by increasing the initial transmit power based on the ratio when the second bandwidth is greater than the first bandwidth. In some such configurations, the means for determining the transmit power may be configured to increase the initial transmit power based on the ratio when the second bandwidth is greater than the first bandwidth in order to determine the transmit power. For example, in one such configuration, the means for determining may be configured to deduce the determined transmit power by increasing the initial transmit power by multiplying the initial transmit power with the ratio when the second bandwidth is greater than the first bandwidth.

In some configurations, the wireless communication device 700 may further comprise means for transmitting the response message using the determined transmit power when the determined transmit power is less than or equal to a maximum transmit power for the wireless device. In some configurations, the wireless communication device 700 may comprise means for transmitting the response message using the maximum transmit power when the determined transmit power is greater than the maximum transmit power for the wireless device.

Moreover, means for performing the various functions described herein may include the receiver 512, the receiver 705, the transmitter 510, the transmitter 715, the processor 504, the processing system 710, the transmission management component 724, the transmission management component 524, the transmission management component 126, and/or one or more other components described with respect to FIGS. 1, 5 and 7.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication by a wireless device, comprising:
receiving a soliciting message with a first bandwidth;
selecting a second bandwidth for transmission of a response message in response to the soliciting message, the second bandwidth being different from the first bandwidth; and
determining a transmit power for the transmission of the response message based on a ratio of the second bandwidth and the first bandwidth.

2. The method of claim 1, further comprising:
transmitting the response message using the determined transmit power when the determined transmit power is less than or equal to a maximum transmit power for the wireless device.

3. The method of claim 1, further comprising:
transmitting the response message using the maximum transmit power when the determined transmit power is greater than the maximum transmit power for the wireless device.

4. The method of claim 1, wherein the determining the transmit power comprises:
reducing an initial transmit power based on the ratio when the second bandwidth is less than the first bandwidth; and
increasing the initial transmit power based on the ratio when the second bandwidth is greater than the first bandwidth,
wherein the initial transmit power is a transmit power for transmission of the response message with the first bandwidth.

5. The method of claim 4, wherein the initial transmit power is reduced by multiplying the initial transmit power by the ratio when the second bandwidth is less than the first bandwidth, the reduced initial transmit power being the determined transmit power.

6. The method of claim 4, wherein the initial transmit power is increased by multiplying the initial transmit power by the ratio when the second bandwidth is greater than the first bandwidth, the increased initial transmit power being the determined transmit power.

7. The method of claim 4, wherein the initial transmit power is determined based on data received by the wireless device.

8. The method of claim 1, wherein a first power spectral density based on the first bandwidth and a transmit power for transmission with the first bandwidth is substantially equal to a second power spectral density based on the second bandwidth and the determined transmit power for transmission with the second bandwidth.

9. The method of claim 1, wherein the first bandwidth is a full bandwidth that the wireless device is capable of using.

10. The method of claim 1, wherein the response message is a control response message.

11. The method of claim 1, wherein the second bandwidth is selected to be less than the first bandwidth.

12. The method of claim 1, wherein the second bandwidth is selected to be greater than the first bandwidth.

13. A wireless device for wireless communication, comprising:
means for receiving a soliciting message with a first bandwidth;
means for selecting a second bandwidth for transmission of a response message in response to the soliciting message, the second bandwidth being different from the first bandwidth; and
means for determining a transmit power for the transmission of the response message based on a ratio of the second bandwidth and the first bandwidth.

14. The wireless device of claim 13, further comprising:
means for transmitting the response message using the determined transmit power when the determined transmit power is less than or equal to a maximum transmit power for the wireless device.

15. The wireless device of claim 13, further comprising:
means for transmitting the response message using the maximum transmit power when the determined transmit power is greater than the maximum transmit power for the wireless device.

16. The wireless device of claim 13, wherein the means for determining the transmit power is configured to:
determine the transmit power by reducing an initial transmit power based on the ratio when the second bandwidth is less than the first bandwidth; and
determine the transmit power by increasing the initial transmit power on the ratio when the second bandwidth is greater than the first bandwidth,
wherein the initial transmit power is a transmit power for transmission with the first bandwidth.

17. The wireless device of claim 16, wherein the initial transmit power is reduced by multiplying the initial transmit power by the ratio when the second bandwidth is less than the first bandwidth.

18. The wireless device of claim 16, wherein the transmit power is increased by multiplying the initial transmit power by the ratio when the second bandwidth is greater than the first bandwidth.

19. The wireless device of claim 16, wherein the initial transmit power is determined based on data received by the wireless device.

20. The wireless device of claim 13, wherein a first power spectral density based on the first bandwidth and a transmit power for transmission with the first bandwidth is substantially equal to a second power spectral density based on the second bandwidth and the determined transmit power for transmission with the second bandwidth.

21. A wireless device for wireless communication, comprising:
a memory; and
at least one processor coupled to the memory and configured to:
receive a soliciting message with a first bandwidth;
select a second bandwidth for transmission of a response message in response to the soliciting message, the second bandwidth being different from the first bandwidth; and
determine a transmit power for the transmission of the response message based on a ratio of the second bandwidth and the first bandwidth.

22. The wireless device of claim 21, wherein the at least one processor is further configured to:
transmit the response message using the determined transmit power when the determined transmit power is less than or equal to a maximum transmit power for the wireless device.

23. The wireless device of claim 21, wherein the at least one processor is further configured to:
transmit the response message using the maximum transmit power when the determined transmit power is greater than the maximum transmit power for the wireless device.

24. The wireless device of claim 21, wherein to determine the transmit power, the at least one processor is configured to:
reduce an initial transmit power to the determined transmit power based on the ratio when the second bandwidth is less than the first bandwidth; and
increase the initial transmit power to the determined the transmit power based on the ratio when the second bandwidth is greater than the first bandwidth,
wherein the initial transmit power is a transmit power for transmission with the first bandwidth.

25. The wireless device of claim 24, wherein the initial transmit power is reduced by multiplying the initial transmit power by the ratio when the second bandwidth is less than the first bandwidth.

26. The wireless device of claim 24, wherein the transmit power is increased by multiplying the initial transmit power by the ratio when the second bandwidth is greater than the first bandwidth.

27. The wireless device of claim 24, wherein the initial transmit power is determined based on data received by the wireless device.

28. The wireless device of claim 21, wherein a first power spectral density based on the first bandwidth and a transmit power for transmission with the first bandwidth is substantially equal to a second power spectral density based on the second bandwidth and the determined transmit power for transmission with the second bandwidth.

29. The wireless device of claim 21, wherein the first bandwidth is a full bandwidth that the wireless device is capable of using.

30. A computer-readable medium having computer-executable code stored thereon that, when executed, causes a wireless device to:
receive a soliciting message with a first bandwidth;
select a second bandwidth for transmission of a response message in response to the soliciting message, the second bandwidth being different from the first bandwidth; and
determine a transmit power for the transmission of the response message based on a ratio of the second bandwidth and the first bandwidth.
